(19) United States
(12) Patent Application Publication
(10) Pub. No.: US 2021/0149616 A1
(43) Pub. Date: May 20, 2021

(54) INFORMATION PRESENTING METHOD, IMAGE FORMING APPARATUS, AND INFORMATION PROCESSING APPARATUS

(71) Applicant: Oki Data Corporation, Tokyo (JP)

(72) Inventor: Koichi HIROMACHI, Tokyo (JP)

(73) Assignee: Oki Data Corporation, Tokyo (JP)

(21) Appl. No.: 17/095,225

(22) Filed: Nov. 11, 2020

(30) Foreign Application Priority Data
Nov. 15, 2019 (JP) 2019-207357

(51) Int. Cl. G06F 3/12

(52) U.S. Cl. CPC G06F 3/1296; G06F 3/1229; G06F 3/1257; G06F 3/1273

(57) ABSTRACT

An information presenting method includes: performing an acquisition process, the acquisition process being a process of acquiring apparatus information, the apparatus information being stored in an image forming apparatus and including setting information, process history information, or both regarding two or more printing data analysis processes, the image forming apparatus selectively executing one of the printing data analysis processes on the basis of printing data; performing a selecting process, the selecting process being a process of selecting one or more printer drivers of two or more printer drivers on the basis of the apparatus information acquired through the acquisition process, the two or more printer drivers corresponding to the respective printing data analysis processes; and performing a display process, the display process being a process of displaying, on a priority basis, information regarding the one or more printer drivers selected through the selecting process.

### CROSS REFERENCE TO RELATED APPLICATIONS

The present application claims priority from Japanese Patent Application No. 2019-207357 filed on Nov. 15, 2019, the entire contents of which are hereby incorporated by reference.

### BACKGROUND

The present technology relates to an information presenting method, an image forming apparatus, and an information processing apparatus that present information.

Upon installing a printer driver on an information processing apparatus, one of two or more usable printer drivers is often chosen, and the chosen printer driver is installed on the information processing apparatus, for example, as disclosed in Japanese Unexamined Patent Application Publication No. 2009-076005.

### SUMMARY

It is desired that an information processing apparatus have high user friendliness in allowing a user to choose a printer driver. It is therefore expected to further improve user friendliness.

It is desirable to provide an information presenting method, an image forming apparatus, and an information processing apparatus that make it possible to improve user friendliness.

According to one embodiment of the technology, there is provided an information presenting method including: performing an acquisition process, the acquisition process being a process of acquiring apparatus information, the apparatus information being stored in an image forming apparatus and including setting information, process history information, or both regarding two or more printing data analysis processes, the image forming apparatus selectively executing one of the printing data analysis processes on the basis of printing data; performing a selecting process, the selecting process being a process of selecting one or more printer drivers of two or more printer drivers on the basis of the apparatus information acquired through the acquisition process, the two or more printer drivers corresponding to the respective printing data analysis processes; and performing a display process, the display process being a process of displaying, on a priority basis, information regarding the one or more printer drivers selected through the selecting process.

According to one embodiment of the technology, there is provided an image forming apparatus that includes a printing data analyzing section, a storage section, a controller, and a communication section. The printing data analyzing section selectively executes one of two or more printing data analysis processes on the basis of printing data. The storage section holds apparatus information. The apparatus information includes setting information, process history information, or both regarding the printing data analysis processes. The controller selects one or more printer drivers of two or more printer drivers on the basis of the apparatus information. The two or more printer drivers correspond to the respective printing data analysis processes. The communication section transmits, to an information processing apparatus, information regarding the one or more selected printer drivers.

According to one embodiment of the technology, there is provided an information processing apparatus that includes a communication section, a processing section, and a display controller. The communication section performs communication with an image forming apparatus and thereby acquires apparatus information. The image forming apparatus selectively executes one of two or more printing data analysis processes on the basis of printing data. The apparatus information includes setting information, process history information, or both regarding the printing data analysis processes. The processing section selects one or more printer drivers of two or more printer drivers on the basis of the acquired apparatus information. The two or more printer drivers correspond to the respective printing data analysis processes. The display controller performs a display control. The display control is a control of displaying information regarding the one or more selected printer drivers on a prior basis.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a block diagram illustrating an example of a configuration of an information processing system according to one example embodiment.

FIG. 2 is an explanatory diagram illustrating an example of printing data.

FIG. 3 is an explanatory diagram illustrating an example of PDL resource data illustrated in FIG. 1

FIG. 4 is an explanatory diagram illustrating an example of history data illustrated in FIG. 1.

FIG. 5 is a sequence diagram illustrating an example of operation of an information processing system illustrated in FIG. 1.

FIG. 6 is a flowchart illustrating an example of operation of an image forming apparatus illustrated in FIG. 1.

FIG. 7 is an explanatory diagram illustrating an example of a WEB page.

FIG. 8 is an explanatory diagram illustrating an example of the WEB page according to a modification.

FIG. 9 is a block diagram illustrating an example of a configuration of an information processing system according to one example embodiment.

FIG. 10 is a sequence diagram illustrating an example of operation of an information processing system illustrated in FIG. 9.

FIG. 11 is an explanatory diagram illustrating an example of a presenting screen.

FIG. 12 is a block diagram illustrating an example of a configuration of an information processing system according to one example embodiment.

FIG. 13 is a sequence diagram illustrating an example of operation of an information processing system illustrated in FIG. 12.

### DETAILED DESCRIPTION

Hereinafter, some example embodiments of the technology will be described in detail with reference to the drawings. Note that the following description is directed to illustrative examples of the technology and not to be construed as limiting to the technology. Factors including, without limitation, numerical values, shapes, materials, components, positions of the components, and how the components are coupled to each other are illustrative only and not to be construed as limiting to the technology. Further, elements in the following example embodiments which are not recited in a most-generic independent claim of the technology are optional and may be provided on an as-needed basis. The drawings are schematic and are not intended to be drawn to scale. Note that the like elements are denoted with the same reference numerals, and any redundant description thereof will not be described in detail. The description will be given in the following order.
1. First Example Embodiment
2. Second Example Embodiment
3. Third Example Embodiment

### 1. First Example Embodiment

[Configuration Example]

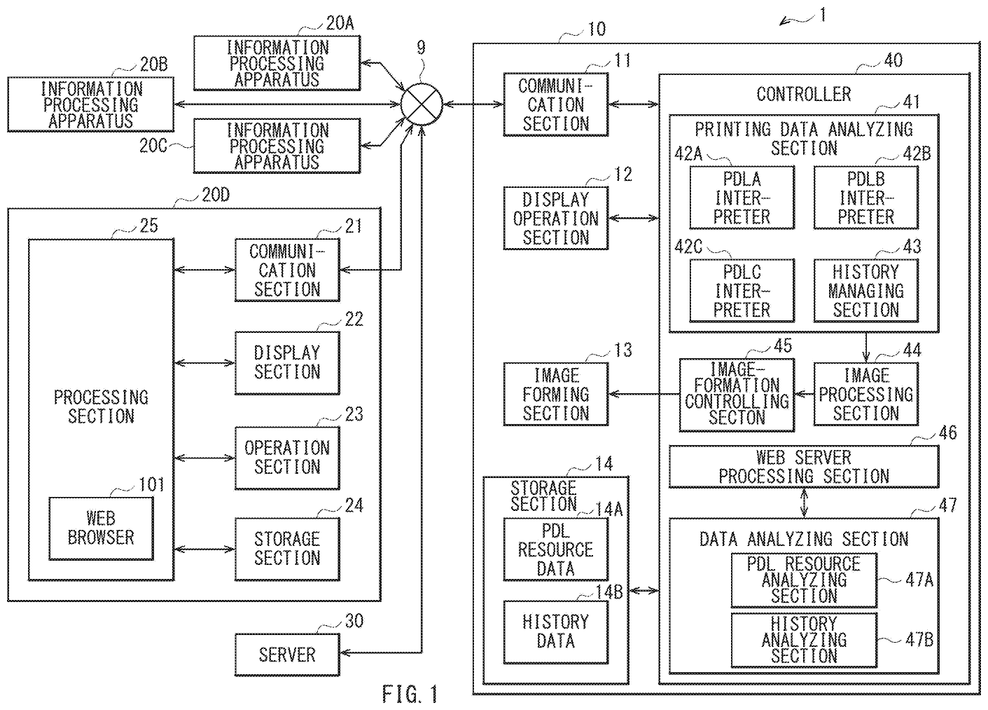

FIG. 1 illustrates an example of a configuration of an information processing system 1 to which an information presenting method according to a first example embodiment of the technology is applied. The information processing system 1 may include, for example but not limited to, an image forming apparatus 10, two or more information processing apparatuses 20, and a server 30. In this non-limiting example, the information processing system 1 may include four information processing apparatuses 20A to 20D as the information processing apparatuses 20. The image forming apparatus 10, the information processing apparatuses 20, and the server 30 may be coupled to each other via a network 9. The image forming apparatus 10 and the information processing apparatuses 20 may be provided at a location such as an office. The image forming apparatus 10 and the information processing apparatuses 20 may be coupled to each other via a network such as a wired local area network (LAN) or a wireless LAN. The image forming apparatus 10 and the information processing apparatuses 20 may be coupled to the server 30 via the Internet.

The image forming apparatus 10 may form an image on a medium such as paper on the basis of printing data DP. The image forming apparatus 10 may support two or more page description languages (PDLs). For example, the image forming apparatus 10 may include two or more interpreters corresponding to the respective page description languages. In the image forming apparatus 10, an interpreter, of the two or more interpreters, that corresponds to the page description language used in the printing data DP may analyze the printing data DP. The image forming apparatus 10 may thereby form an image on the medium on the basis of the printing data DP.

The information processing apparatuses 20 may each be a so-called personal computer in this example. In this example, the information processing apparatus 20A may have an identifier of “PCA”, the information processing apparatus 20B may have an identifier of “PCB”, the information processing apparatus 20C may have an identifier of “PCC”, and the information processing apparatus 20D may have an identifier of “PCD”. In each of the information processing apparatuses 20, two or more printer drivers may be usable that correspond to the respective page description languages supported by the image forming apparatus 10. In this example, the information processing apparatuses 20A to 20C may have printer drivers for the image forming apparatus 10 already installed thereon.

The server 30 may be managed, for example, by a manufacturer of the image forming apparatus 10. The server 30 may provide printer drivers for the image forming apparatus 10. For example, when a printer driver for the image forming apparatus 10 is to be installed on any of the information processing apparatuses 20 (e.g., the information processing apparatus 20D), the server 30 may transmit the printer driver to the information processing apparatus 20D in response to a request from the information processing apparatus 20D.

With this configuration, in the information processing system 1, when the user installs the printer driver on the information processing apparatus 20D, the image forming apparatus 10 may generate a WEB page P on the basis of setting information regarding two or more interpreters (i.e., PDL resource data 14A described later) and process history information (i.e., history data 14B described later) of the interpreters. The WEB page P may indicate a candidate of the printer driver to be installed. The information processing apparatus 20D may display the generated WEB page P, and may thereby present, to the user, the printer driver to be installed. In a case where the user is unsure of which printer driver to install, this allows the information processing system 1 to help the user to choose the printer driver.

[Image Forming Apparatus 10]

The image forming apparatus 10 may include, for example but not limited to, a communication section 11, a display operation section 12, an image forming section 13, a storage section 14, and a controller 40.

The communication section 11 may perform communication with the information processing apparatuses 20 via the network 9. The communication section 11 may receive, for example, the printing data DP transmitted from any of the information processing apparatuses 20.

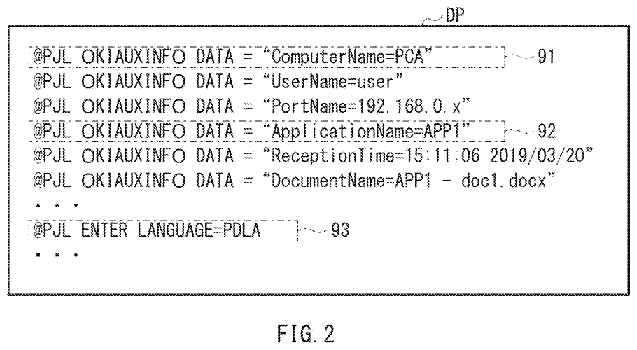

FIG. 2 illustrates an example of the printing data DP transmitted from the information processing apparatus 20A. The printing data DP may include job commands 91 to 93. The job command 91 may include an identifier of an information processing apparatus that has transmitted the printing data DP. In this example, the job command 91 includes “PCA” which is the identifier of the information processing apparatus 20A. The job command 92 may include a software name of application software that has generated to-be-printed data included in the printing data DP. In this example, the job command 92 includes “APP1” that is a software name of the application software that has generated the to-be-printed data included in the printing data DP. The job command 93 may include a language name of the page description language used in the printing data DP. In this example, the job command 93 includes “PDLA” that is a language name of the page description language used in the printing data DP.

The communication section 11 may receive the printing data DP described above. Further, the communication section 11 may receive a transmission request for the WEB page P transmitted from the information processing apparatus 20D. The wording “transmission request for the WEB page P” refers to a request that the WEB page P be transmitted. The WEB page P may indicate a candidate of the printer driver to be installed. The communication section 11 may transmit page data of the requested WEB page P to the information processing apparatus 20D.

The display operation section 12 may receive operation performed by the user, and may display, for example but not limited to, an operation state of the image forming apparatus 10. The display operation section 12 may include, for example but not limited to, a touch panel, various buttons, a liquid crystal display, and various indicators.

The image forming section 13 may form an image on a medium with use of a developer. Non-limiting examples of the image may include a monochrome image and a color image. Non-limiting examples of the medium may include paper. Non-limiting examples of the developer may include a toner. The image forming section 13 may include, for example but not limited to: an image drum unit that forms a developer image; a transfer section that transfers the developer image onto the medium; and a fixing section that fixes, to the medium, the developer image on the medium.

The storage section 14 may hold, for example but not limited to, firmware and various apparatus setting values. The storage section 14 may include, for example but not limited to, a non-volatile semiconductor memory such as a flash memory. The storage section 14 may hold the PDL resource data 14A and the history data 14B.

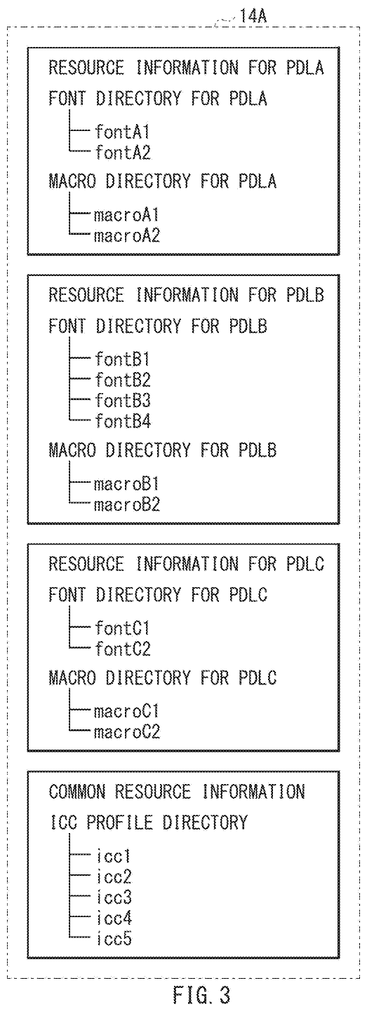

FIG. 3 illustrates an example of a configuration of the PDL resource data 14A. As described later, the image forming apparatus 10 may support three page description languages PDLA, PDLB, and PDLC. In this non-limiting example, the page description language PDLA may be PCLXL, the page description language PDLB may be PostScript (registered trademark), and the page description language PDLC may be PCL5c. In the PDL resource data 14A, resource information for the page description language PDLA, resource information for the page description language PDLB, resource information for the page description language PDLC, and common resource information common to the page description languages PDLA, PDLB, and PDLC may be managed separately from each other. The pieces of resource information described above may be stored in the storage section 14 on the basis of the operation performed by the user.

The resource information for the page description language PDLA (i.e., PCLXL, in this example) may include two pieces of font information, i.e., fontA1 and fontA2, and two pieces of macro information, i.e., macroA1 and macroA2. The two pieces of font information fontA1 and fontA2 and the two pieces of macro information macroA1 and macroA2 may be stored in a file format in the storage section 14. That is, the resource information for the page description language PDLA may include four files.

The two pieces of font information fontA1 and fontA2 may each be information regarding a font that is usable in the image forming apparatus 10. The two pieces of font information fontA1 and fontA2 may each be downloaded from an unillustrated server and stored in the storage section 14 on the basis of operation performed by the user. The image forming apparatus 10 may be configured to form a character image with use of the pieces of font information fontA1 and fontA2 on the basis of instruction information included in the printing data DP.

The two pieces of macro information macroA1 and macroA2 may each be information regarding a macro that is usable in the image forming apparatus 10. The pieces of macro information macroA1 and macroA2 may be set and stored in the storage section 14 on the basis of operation performed by the user. The image forming apparatus 10 may be allowed to, for example, generate a so-called watermark or generate a page number with use of a macro. The image forming apparatus 10 may be allowed to form an image with use of the pieces of macro information macroA1 and macroA2 on the basis of the instruction information included in the printing data DP.

Similarly, the resource information for the page description language PDLB (PostScript, in this example) may include four pieces of font information fontB1, fontB2, fontB3, and fontB4 and two pieces of macro information macroB1 and macroB2. That is, the resource information for the page description language PDLB may include six files.

Similarly, the resource information for the page description language PDLC (PCL5c, in this example) may include two pieces of font information fontC1 and fontC2 and two pieces of macro information macroC1 and macroC2. That is, the resource information for the page description language PDLC may include four files.

The common resource information may include five pieces of international color consortium (ICC) profile information icc1 to icc5. That is, the common resource information may include five files. The pieces of ICC profile information icc1 to icc5 may each be information regarding color management in the image forming apparatus 10. The pieces of ICC profile information icc1 to icc5 may be downloaded from an unillustrated server and stored in the storage section 14 on the basis of operation performed by the user. The image forming apparatus 10 may be configured to perform an image forming process with use of the pieces of ICC profile information icc1 to icc5 on the basis of instruction information included in the printing data DP.

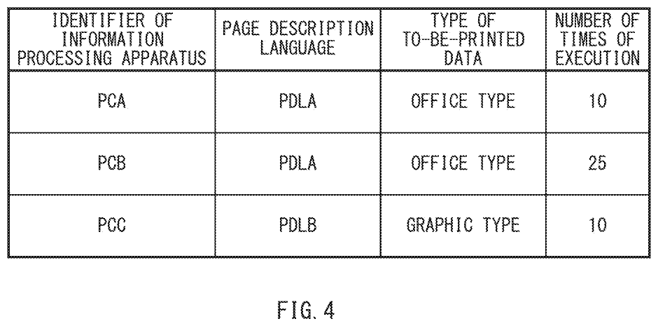

FIG. 4 illustrates an example of the history data 14B. The history data 14B may include information regarding a process history of the image forming process which the image forming apparatus 10 has executed in the past. The history data 14B may include: information regarding the identifier of the information processing apparatus that has transmitted the printing data DP; information regarding the page description language that has been used; information regarding a type of the to-be-printed data included in the printing data DP; and information regarding the number of times of execution of the image forming process. The history data 14B illustrated in FIG. 4 indicates that the image forming process has been performed ten times with use of the page description language PDLA (PCLXL, in this example) on the basis of the printing data DP, which includes office-type to-be-printed data, transmitted from the information processing apparatus 20A associated with the identifier “PCA”. The history data 14B also indicates that the image forming process has been performed twenty-five times with use of the page description language PDLA (PCLXL, in this example) on the basis of the printing data DP, which includes office-type to-be-printed data, transmitted from the information processing apparatus 20B associated with the identifier “PCB”. The history data 14B also indicates that the image forming process has been performed ten times with use of the page description language PDLB (PostScript, in this example) on the basis of the printing data DP, which includes graphic-type to-be-printed data, transmitted from the information processing apparatus 20C associated with the identifier “PCC”. The “office-type” to-be-printed data may refer to, for example, data created by so-called office-type application software such as word processor software, spreadsheet software, or presentation software. The “graphic-type” to-be-printed data may refer to, for example, data created by graphic-type application software such as image editing software.

The controller 40 illustrated in FIG. 1 may control operation in the image forming apparatus 10. The controller 40 may include, for example but not limited to, a central processing unit (CPU) and a random-access memory (RAM). The controller 40 may include, for example but not limited to, a printing data analyzing section 41, an image processing section 44, an image-formation controlling section 45, a world wide web (WEB) server processing section 46, and a data analyzing section 47.

The printing data analyzing section 41 may analyze a print command included in the printing data DP transmitted from the information processing apparatus 20. The printing data analyzing section 41 may include, for example but not limited to, a PDLA interpreter 42A, a PDLB interpreter 42B, a PDLC interpreter 42C, and a history managing section 43.

The PDLA interpreter 42A may analyze a print command included in the printing data DP described in the page description language PDLA (PCLXL, in this example). The PDLB interpreter 42B may analyze a print command included in the printing data DP described in the page description language PDLB (PostScript, in this example). The PDLC interpreter 42C may analyze a print command included in the printing data DP described in the page description language PDLC (PCL5c, in this example).

The history managing section 43 may update the history data 14B illustrated in FIG. 4 every time the image forming apparatus 10 performs the image forming process on the basis of the printing data DP transmitted from the information processing apparatus 20. For example, the history managing section 43 may acquire, on the basis of the job command 91 included in the printing data DP, the identifier of the information processing apparatus 20 that has transmitted the printing data DP. Further, the history managing section 43 may acquire, on the basis of the job command 92 included in the printing data DP, the software name of the application software that has generated the to-be-printed data included in the printing data DP. Further, the history managing section 43 may acquire, on the basis of the job command 93 included in the printing data DP, the language name of the page description language to be used. The history managing section 43 may identify the type of the to-be-printed data on the basis of the software name of the application software that has generated the to-be-printed data. The history managing section 43 may update the history data 14B on the basis of the identifier of the information processing apparatus 20 that has transmitted the printing data DP, the page description language to be used, and the type of the to-be-printed data included in the printing data DP.

The image processing section 44 may generate, on the basis of the print command analyzed by the printing data analyzing section 41, an image to be formed on the medium.

The image-formation controlling section 45 may control operation of the image forming section 13 on the basis of an image generated by the image processing section 44.

The WEB server processing section 46 may generate page data of the WEB page P on the basis of the transmission request, for the WEB page P, received from the information processing apparatus 20 with use of a hypertext transfer protocol (HTTP). For example, the WEB server processing section 46 may generate, on the basis of a result of the analysis performed by the data analyzing section 47, page data of the WEB page P indicating a candidate of a printer driver to be installed.

The data analyzing section 47 may analyze the PDL resource data 14A and the history data 14B. The data analyzing section 47 may include a PDL resource analyzing section 47A and a history analyzing section 47B. The PDL resource analyzing section 47A may analyze the PDL resource data 14A, and may thereby determine a page description language that is great in quantity of resource information. The history analyzing section 47B may analyze the history data 14B, and may thereby determine the page description language that is great in frequency of use.

[Information Processing Apparatus 20]

Next, a description is given of an example of a configuration of the information processing apparatus 20, taking the information processing apparatus 20D as an example. In this example, the information processing apparatuses 20A to 20C may each have a configuration similar to that of the information processing apparatus 20D. The information processing apparatus 20D may include, for example but not limited to, a communication section 21, a display section 22, an operation section 23, a storage section 24, and a processing section 25.

The communication section 21 may perform communication between the communication section 21 and each of the image forming apparatus 10 and the server 30 via the network 9. For example, the communication section 21 may make, to the image forming apparatus 10, a transmission request for the WEB page P indicating a candidate of the printer driver to be installed, and may receive the page data of the WEB page P transmitted from the image forming apparatus 10. The communication section 21 may make, to the server 30, a transmission request for the printer driver, and may receive the printer driver transmitted from the server 30. The communication section 21 may transmit the printing data DP generated by the installed printer driver to the image forming apparatus 10.

The display section 22 may display, for example, an image indicating the operation state of the information processing apparatus 20D, an image indicating an instruction for the user, or any other image. The display section 22 may include, for example but not limited to, a liquid crystal display.

The operation section 23 may receive operation performed by the user. The operation section 23 may include, for example but not limited to, a keyboard and a mouse.

The storage section 24 may hold various data or various programs to be used in the information processing apparatus 20D including, without limitation, an operating system, application software, and a printer driver. The storage section 24 may include, for example but not limited to, a hard disk drive (HDD) or a solid state drive (SSD).

The processing section 25 may control operation of the information processing apparatus 20D, and may perform various processes. The processing section 25 may include, for example but not limited to, a CPU and a RAM. The information processing apparatus 20D may include a WEB browser 101 installed thereon. The processing section 25 may execute the WEB browser 101 on the basis of the operation performed by the user. The processing section 25 may thereby display so control the display section 22 and the operation section 23, on the basis of the page data of the WEB page P transmitted from the image forming apparatus 10, that the display section 22 displays the WEB page P indicating the candidate of the printer driver to be installed and the operation section 23 receives choosing operation of the printer driver performed by the user. The choosing operation of the printer driver refers to operation of choosing a printer driver. The processing section 25 may make, on the basis of the choosing operation performed by the user, a transmission request, to the server 30, for the chosen printer driver. The processing section 25 may also install, on the information processing apparatus 20D, the printer driver transmitted from the server 30.

[Server 30]

The server 30 may transmit a printer driver to the information processing apparatus 20D in response to a transmission request, for the printer driver, received from the information processing apparatus 20D. The server 30 may include, for example but not limited to, a CPU, a RAM, an HDD, and any other device.

The server 30 may hold two or more printer drivers for the image forming apparatus 10. The printer drivers may include: a printer driver, for the page description language PDLA, that generates the printing data DP described in the page description language PDLA; a printer driver, for the page description language PDLB, that generates the printing data DP described in the page description language PDLB; and a printer driver, for the page description language PDLC, that generates the printing data DP described in the page description language PDLC. The server 30 may transmit, to the information processing apparatus 20D, a printer driver, of the two or more printer drivers, according to the transmission request from the information processing apparatus 20D.

The printing data analyzing section 41 may correspond to a “printing data analyzing section” in one specific but non-limiting embodiment of the technology. The processes performed in the PDLA interpreter 42A, the PDLB interpreter 42B, and the PDLC interpreter 42C may correspond to “two or more printing data analysis processes” in one specific but non-limiting embodiment of the technology. The storage section 14 may correspond to a “storage section” in one specific but non-limiting embodiment of the technology. The PDL resource data 14A may correspond to “setting information” in one specific but non-limiting embodiment of the technology. The history data 14B may correspond to “process history information” in one specific but non-limiting embodiment of the technology. The controller 40 may correspond to a “controller” in one specific but non-limiting embodiment of the technology. The communication section 11 may correspond to a “communication section” of an “image forming apparatus” in one specific but non-limiting embodiment of the technology.

[Operation and Example Workings]

Next, a description is given of operation and example workings of the information processing system 1 according to the first example embodiment.

[Overview of Overall Operation]

First, referring to FIG. 1, an overview of overall operation of the information processing system 1 is described. For example, the processing section 25 of the information processing apparatus 20A may execute the installed printer driver on the basis of operation performed by the user, and may thereby generate the printing data DP. In the image forming apparatus 10, the printing data analyzing section 41 may analyze the print command included in the generated printing data DP. The history managing section 43 of the printing data analyzing section 41 may update the history data 14B on the basis of: the identifier of the information processing apparatus 20A that has transmitted the printing data DP; the page description language to be used; and the type of the to-be-printed data included in the printing data DP. The image processing section 44 may generate an image, which is to be formed on the medium, on the basis of the print command analyzed by the printing data analyzing section 41. The image-formation controlling section 45 may control operation of the image forming section 13 on the basis of the image generated by the image processing section 44. The image forming section 13 may form an image such as a monochrome image or a color image on a medium such as paper with use of a developer such as a toner on the basis of an instruction given from the image-formation controlling section 45.

For example, in a case where a printer driver is to be installed on the information processing apparatus 20D, the processing section 25 of the information processing apparatus 20D may execute the WEB browser 101 on the basis of the operation performed by the user, and may thereby make, to the image forming apparatus 10, a transmission request for the WEB page P indicating a candidate of the printer driver to be installed. In the image forming apparatus 10, the data analyzing section 47 may analyze the PDL resource data 14A and the history data 14B. The WEB server processing section 46 may generate, on the basis of a result of the analysis performed by the data analyzing section 47, page data of the WEB page P indicating the candidate of the printer driver to be installed. In the information processing apparatus 20D, the processing section 25 executing the WEB browser 101 may so control, on the basis of the page data, the display section 22 and the operation section 23 that the display section 22 displays the WEB page P and the operation section 23 receives the choosing operation of the printer driver performed by the user. The processing section 25 may make, to the server 30, a transmission request for the chosen printer driver on the basis of the choosing operation performed by the user. The server 30 may transmit the printer driver to the information processing apparatus 20D in response to the received transmission request. The processing section 25 of the information processing apparatus 20D may install the printer driver on the information processing apparatus 20D.

[Detailed Operation]

Next, a detailed description is given of operation of the information processing system 1 in a case where a printer driver is to be installed on the information processing apparatus 20D.

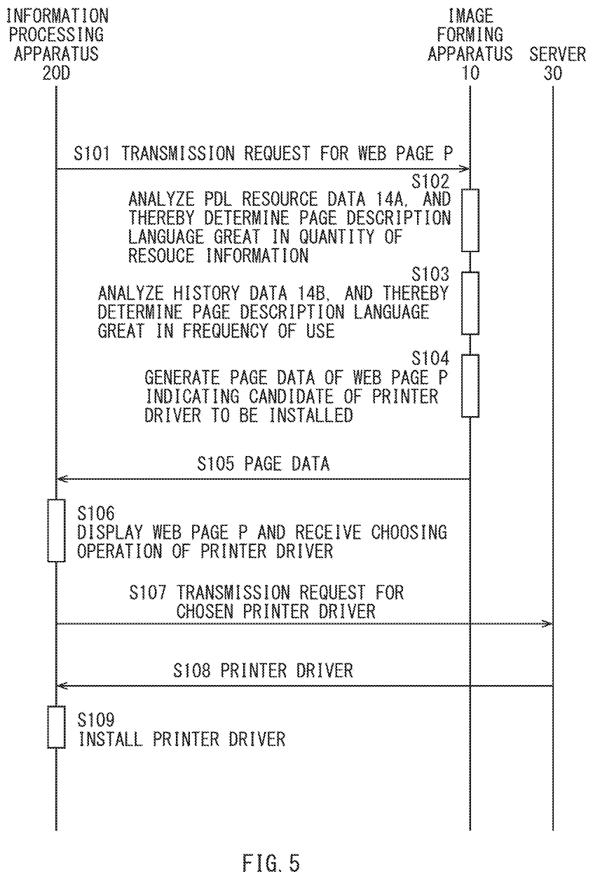

FIG. 5 illustrates an example of the operation of the information processing system 1.

First, the information processing apparatus 20D may make, to the image forming apparatus 10, a transmission request for the WEB page P indicating the candidate of the printer driver to be installed (step S101). For example, the processing section 25 of the information processing apparatus 20D may access the image forming apparatus 10 on the basis of a uniform resource locator (URL) of the image forming apparatus 10, and may thereby make, to the image forming apparatus 10, the transmission request for the WEB page P. The URL of the image forming apparatus 10 may have been inputted by the user through the WEB browser 101. The communication section 21 of the information processing apparatus 20D may transmit the transmission request to the image forming apparatus 10. The communication section 11 of the image forming apparatus 10 may receive the transmission request.

Thereafter, the PDL resource analyzing section 47A of the image forming apparatus 10 may analyze the PDL resource data 14A, and may thereby determine the page description language that is great in quantity of the resource information among the page description languages PDLA, PDLB, and PDLC (step S102). Thereafter, the history analyzing section 47B may analyze the history data 14B, and may thereby determine the page description language that is great in frequency of use among the page description languages PDLA, PDLB, and PDLC (step S103). Thereafter, the WEB server processing section 46 may generate, on the basis of results of the determinations made in steps S101 and S102, page data of the WEB page P indicating the candidate of the printer driver to be installed (step S104).

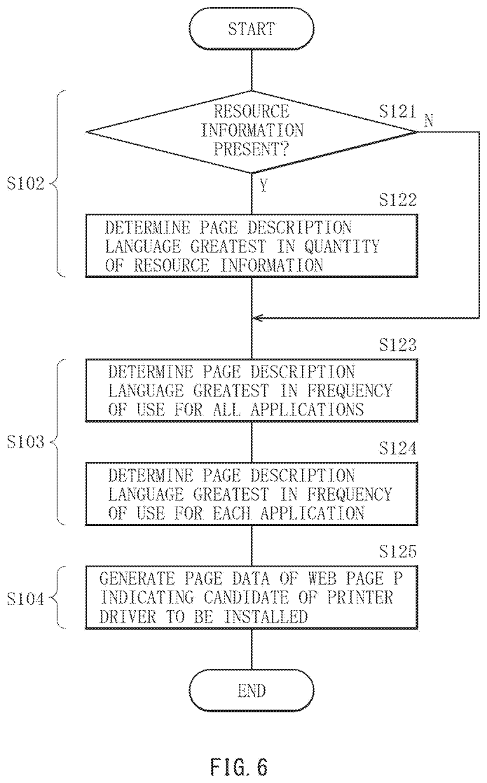

FIG. 6 illustrates an example of operation of the PDL resource analyzing section 47A, the history analyzing section 47B, and the WEB server processing section 46 in steps S102 to S104. Steps S121 and S122 may correspond to the step S102 illustrated in FIG. 5. Steps S123 and S124 may correspond to the step S103 illustrated in FIG. 5. Step S125 may correspond to the step S104 illustrated in FIG. 5.

First, the PDL resource analyzing section 47A may analyze the PDL resource data 14A, and may thereby confirm whether the resource information is present (step S121). For example, in the example illustrated in FIG. 3, the resource information for the page description language PDLA includes four files, the resource information for the page description language PDLB includes six files, the resource information for the page description language PDLC includes four files, and the common resource information includes five files. Accordingly, the PDL resource analyzing section 47A may determine that the resource information is present. In contrast, for example, in a case where no resource information includes any file, the PDL resource analyzing section 47A may determine that the resource information is not present. In a case where the resource information is not present (“N” in step S121), the process may be caused to proceed to step S123.

In a case where the resource information is present in step S121 (“Y” in step S121), the PDL resource analyzing section 47A may determine, on the basis of the PDL resource data 14A, the page description language that is greatest in quantity of the resource information among the page description languages PDLA, PDLB, and PDLC (step S122). In the example illustrated FIG. 3, the resource information for the page description language PDLA (PCLXL, in this example) includes four files, the resource information for the page description language PDLB (PostScript, in this example) includes six files, and the resource information for the page description language PDLC (PCL5c, in this example) includes four files. Here, the five pieces of ICC profile information included in the common resource information may be mostly used in PostScript. Therefore, the five pieces of ICC profile information may be counted as the resource information for the page description language PDLB in this example. Consequently, the resource information for the page description language PDLA includes four files, the resource information for the page description language PDLB includes eleven files (=6+5), and the resource information for the page description language PDLC includes four files. Accordingly, the PDL resource analyzing section 47A may determine that the page description language PDLB is the page description language that is greatest in quantity of the resource information.

Thereafter, the history analyzing section 47B may analyze the history data 14B, and may thereby determine the page description language that is greatest in frequency of use for all applications, among the page description languages PDLA, PDLB, and PDLC (step S123). In the example illustrated in FIG. 4, the page description language PDLA (PCLXL, in this example) is used to execute the image forming process thirty-five times (=10+25). The page description language PDLB (PostScript, in this example) is used to execute the image forming process ten times. Accordingly, the history analyzing section 47B may determine that the page description language PDLA is the page description language that is greatest in frequency of use for all applications.

Thereafter, the history analyzing section 47B may analyze the history data 14B, and may thereby determine the page description language that is greatest in frequency of use for each of the applications, among the page description languages PDLA, PDLB, and PDLC (step S124). In the example illustrated in FIG. 4, the page description language PDLA (PCLXL, in this example) is used to execute the image forming process for thirty-five times (=10+25) on the basis of the printing data DP including the office-type to-be-printed data. The page description language PDLB (PostScript, in this example) is used to execute the image forming process ten times on the basis of the printing data DP including the graphic-type to-be-printed data. Accordingly, the history analyzing section 47B may determine that the page description language PDLA (PCLXL, in this example) is the page description language that is greatest in frequency of use for the application of printing the office-type to-be-printed data, and may determine that the page description language PDLB (PostScript, in this example) is the page description language that is greatest in frequency of use for the application of printing the graphic-type to-be-printed data.

Thereafter, the WEB server processing section 46 of the image forming apparatus 10 may generate, on the basis of results of the processes in steps S121 to S124, the page data of the WEB page P indicating the candidate of the printer driver to be installed (step S125).

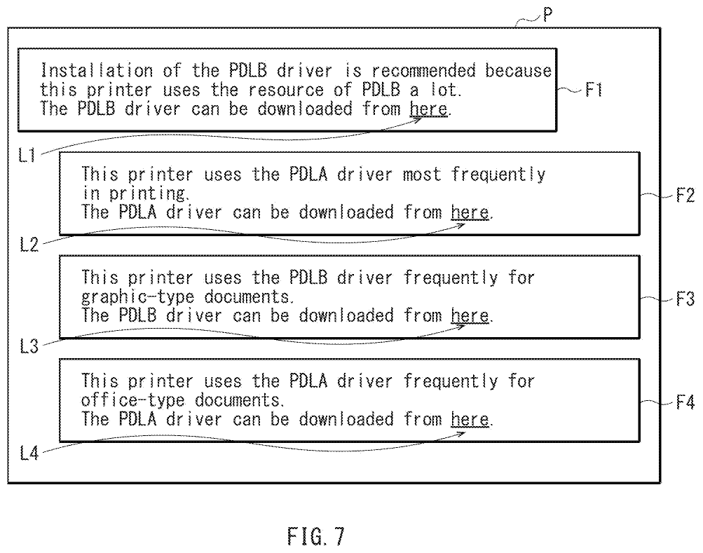

FIG. 7 illustrates an example of the WEB page P. This WEB page P may include four fields F1 to F4.

The field F1 on the top may include a message that recommends installing the printer driver for the page description language PDLB. That is, in this example, as determined in step S122, the page description language PDLB is the page description language that is greatest in quantity of the resource information. Because the great quantity of the resource information may be convenient for the user, the WEB server processing section 46 may generate the message that recommends installing the printer driver for the page description language PDLB. Set in the field F1 may be a hyperlink L1 for downloading the printer driver for the page description language PDLB from the server 30. For example, the printer driver for the page description language PDLB may be downloaded from the server 30 in response to operation performed by the user on the hyperlink L1. The field F2 below may include a message that the printer driver for the page description language PDLA is greatest in frequency of use. That is, in this example, as determined in step S123, the page description language PDLA is the page description language that is greatest in frequency of use for all of the applications. Accordingly, the WEB server processing section 46 may generate such a message. Set in the field F2 may be a hyperlink L2 for downloading the printer driver for the page description language PDLA from the server 30.

The field F3 below may include a message that the printer driver for the page description language PDLB is greatest in frequency of use for the graphic-type document. That is, in this example, as determined in step S124, the page description language PDLB is the page description language that is greatest in frequency of use for an application of printing the graphic-type to-be-printed data print. Accordingly, the WEB server processing section 46 may generate such a message. Set in the field F3 may be a hyperlink L3 for downloading the printer driver for the page description language PDLB from the server 30.

The field F4 below may include a message that the printer driver for the page description language PDLA is greatest in frequency of use for the office-type document. That is, in this example, as determined in step S124, the page description language PDLA is the page description language that is greatest in frequency of use for an application of printing the office-type to-be-printed data. Accordingly, the WEB server processing section 46 may generate such a message. Set in the field F4 may be a hyperlink L4 for downloading the printer driver for the page description language PDLA from the server 30.

Note that, in this example, only the hyperlinks L2 and L4 for downloading the printer driver for the page description language PDLA and the hyperlinks L1 and L3 for downloading the printer driver for the page description language PDLB may be set; however, this is non-limiting. For example, another field may be provided, below the field F4, in which two or more hyperlinks for downloading all of the printer drivers related to the image forming apparatus 10 are set. This allows the user to download the printer driver which the user wishes to install but whose hyperlink is not provided in any of the fields F1 to F4, for example.

Thereafter, as illustrated in FIG. 5, the communication section 11 of the image forming apparatus 10 may transmit the page data of the WEB page P described above to the information processing apparatus 20D (step S105). The communication section 21 of the information processing apparatus 20D may receive the transmitted page data.

Thereafter, the display section 22 of the information processing apparatus 20D may display the WEB page P, and the operation section 23 may receive the choosing operation of the printer driver performed by the user (step S106). For example, the processing section 25 executing the WEB browser 101 may so control, on the basis of the page data received in step S105, the display section 22 and the operation section 23 that the display section 22 displays the WEB page P and the operation section 23 receives the operation performed on any of the hyperlinks L1 to L4 by the user.

Thereafter, the processing section 25 of the information processing apparatus 20D may make, to the server 30, a transmission request for the chosen printer driver, in response to the choosing operation performed by the user, and the communication section 21 may transmit the transmission request to the server 30 (step S107). The server 30 may receive the transmitted transmission request.

Thereafter, the server 30 may transmit, to the information processing apparatus 20D, the printer driver according to the transmission request from the information processing apparatus 20D, among the printer driver for the page description language PDLA, the printer driver for the page description language PDLB, and the printer driver for the page description language PDLC (step S108). The communication section 21 of the information processing apparatus 20D may receive the transmitted printer driver.

Thereafter, the processing section 25 of the information processing apparatus 20D may install the printer driver received in step S108 on the information processing apparatus 20D (step S109).

This may bring the sequence to an end.

As described above, in the information processing system 1, one or more printer drivers of the two or more printer drivers corresponding to the respective two or more interpreters may be selected on the basis of the PDL resource data 14A which is the setting information regarding the interpreters of the image forming apparatus 10. Further, information regarding the one or more selected printer drivers may be displayed on a priority basis. Accordingly, in the information processing system 1, for example, the printer driver corresponding to the page description language that is greatest in quantity of the resource information may be allowed to be displayed, on a priority basis, as a candidate of the printer driver to be installed. As a result, it is possible for the information processing system 1 to help the user to choose the printer driver in a case where the user is unsure of which printer driver to install. That is, in a case of installing a printer driver for the image forming apparatus that supports two or more page description languages, it may be difficult for the user to determine which printer driver to install by himself or herself. The information processing system 1 may select one or more printer drivers of the two or more printer drivers on the basis of the PDL resource data 14A, and may display information regarding the one or more selected printer drivers on a priority basis. Accordingly, for example, the user is allowed to choose one of the one or more displayed printer drivers. Further, for example, in a case where the one or more printer drivers include a printer driver corresponding to the page description language that is greatest in quantity of the resource information, the user is allowed to choose the convenient printer driver that has great quantity of resource information. Accordingly, it is possible to improve user friendliness.

Further, in the information processing system 1, one or more printer drivers of the two or more printer drivers corresponding to the respective two or more interpreters may be selected on the basis of the history data 14B which is the process history information of the interpreters in the image forming apparatus 10. Further, information regarding the one or more selected printer drivers may be displayed on a priority basis. Accordingly, the information processing system 1 is allowed to display, as a candidate of the printer driver to be installed, the printer driver for the page description language that is greatest in frequency of use for all of the applications or the printer driver for the page description language that is greatest in frequency of use for each of the applications on a priority basis. As a result, it is possible for the information processing system 1 to help the user to choose the printer driver in a case where the user is unsure of which printer driver to install. Accordingly, it is possible to improve user friendliness.

Further, in the information processing system 1, the image forming apparatus 10 may generate the WEB page P indicating the candidate of the printer driver to be installed, and the information processing apparatus 20D may display the WEB page P. This may allow, for example, the information processing apparatus 20D to download the printer driver from the server 30 on the basis of the operation performed by the user. Thus, the information processing system 1 may not use any installer for installing the printer driver. Therefore, for example, the user does not need to prepare the installer, which saves time and effort of the user. Further, because the installer is not installed on the information processing apparatus 20D, the information processing apparatus 20D does not have any later-unnecessary software installed thereon. As a result, the information processing system 1 makes it possible to improve user friendliness.

### Example Effects

As described above, according to the first example embodiment, one or more printer drivers of the two or more printer drivers corresponding to the respective two or more interpreters may be selected on the basis of the PDL resource data that is the setting information regarding the interpreters in the image forming apparatus. Further, the information regarding the one or more selected printer drivers may be displayed on a priority basis. Accordingly, it is possible to increase user friendliness.

According to the first example embodiment, one or more printer drivers of the two or more printer drivers corresponding to the respective two or more interpreters may be selected on the basis of the history data that is the process history information of the interpreters in the image forming apparatus. Further, the information regarding the one or more selected printer drivers may be displayed on a priority basis. Accordingly, it is possible to increase user friendliness.

According to the first example embodiment, the image forming apparatus may generate the WEB page that indicates a candidate of the printer driver to be installed, and the information processing apparatus may display the generated WEB page. Accordingly, it is possible to increase user friendliness.

[Modification 1-1]

According to the first example embodiment, as illustrated in FIG. 5, the data analyzing section 47 of the image forming apparatus 10 may perform both of the process in step S102 and the process in step S103. That is, the data analyzing section 47 may analyze the PDL resource data 14A and may thereby determine the page description language that is greatest in quantity of the resource information (step S102), and the data analyzing section 47 may also analyze the history data 14B and may thereby determine the page description language that is greatest in frequency of use (step S103). However, this is non-limiting. Alternatively, for example, the data analyzing section 47 may perform only one of the processes in steps S102 and S103.

[Modification 1-2]

According to the first example embodiment, as illustrated in step S122 of FIG. 6, the PDL resource analyzing section 47A may determine the page description language that is greatest in quantity of the resource information among the page description languages PDLA, PDLB, and PDLC on the basis of the PDL resource data 14A. However, this is non-limiting. Alternatively, for example, the PDL resource analyzing section 47A may determine the page description language that is second greatest in quantity of the resource information in addition to the page description language that is greatest in quantity of the resource information.

[Modification 1-3]

According to the first example embodiment, as illustrated in FIG. 7, pieces of information may be displayed side by side on the WEB page P in order of the page description language that is greatest in quantity of the resource information, the page description language that is greatest in frequency of use for all of the applications, and the page description language that is greatest in frequency of use for each of the applications. However, this is non-limiting. Alternatively, for example, the pieces of information may be displayed side by side in order of the quantity of the resource information related to the page description language. For example, in a case where there are two or more page description languages having the same number of resource information, pieces of information regarding those two or more page description languages may be displayed side by side in order of the frequency of use of the page description language.

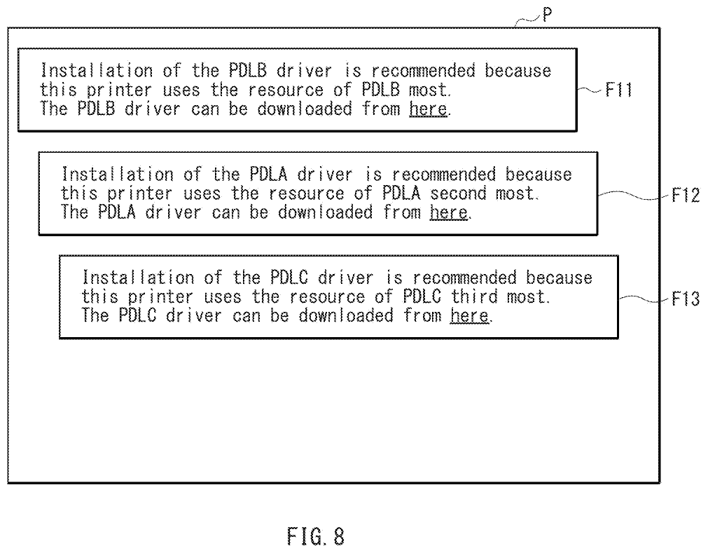

FIG. 8 illustrates an example of the WEB page P according to Modification 1-3 described above. The WEB page P may include three fields F11 to F13.

The field F11 on the top may include a message that recommends installing the printer driver for the page description language PDLB. That is, in the example illustrated in FIG. 3, the page description language PDLB is the page description language that is greatest in quantity of the resource information. Accordingly, the WEB server processing section 46 may place information regarding the printer driver for the page description language PDLB at the top.

The field F12 below may include a message that recommends installing the printer driver for the page description language PDLA. The field F13 below may include a message that recommends installing the printer driver for the page description language PDLC. That is, in the example illustrated in FIG. 3, the page description language PDLA and the page description language PDLC are the page description languages that are second greatest in quantity of the resource information. As illustrated in FIG. 4, the page description language PDLA may be greater in frequency of use than the page description language PDLC. Accordingly, the WEB server processing section 46 may place information regarding the printer driver for the page description language PDLA, and may place information regarding the printer driver for the page description language PDLC below the information regarding the printer driver for the page description language PDLA.

[Modification 1-4]

According to the first example embodiment, as illustrated in FIG. 7, information regarding two or more printer drivers may be displayed. However, this is non-limiting. Alternatively, for example, information regarding only one printer driver may be displayed.

[Modification 1-5]

According to the first example embodiment, as illustrated in FIG. 7, information regarding the printer driver for the page description language PDLA and the printer driver for the page description language PDLB may be displayed among the printer driver for the page description language PDLA, the printer driver for the page description language PDLB, and the printer driver for the page description language PDLC. This allows for display of the information regarding the printer driver for the page description language PDLA and the printer driver for the page description language PDLB on a priority basis. However, this is non-limiting. Alternatively, for example, information regarding all of the printer drivers may be displayed, while, for example, displayed parts corresponding to the printer driver for the page description language PDLA and the printer driver for the page description language PDLB may be changed in color or font. In another example, information regarding all of the printer drivers may be displayed, while numbers may be displayed at the displayed parts in order to indicate an order of recommendation. This also allows for display of the information regarding the printer driver for the page description language PDLA and the printer driver for the page description language PDLB on a priority basis.

[Other Modifications]

Moreover, two or more of the modifications described above may be adopted in combination.

### 2. Second Example Embodiment

Next, a description is given of an information processing system 2 according to a second example embodiment. The information processing system 2 may include, for example but not limited to, an information processing apparatus that executes an installer for installing a printer driver. The information processing apparatus may display a presenting screen Q on the basis of a result of an analysis performed by the data analyzing section 47 of the image forming apparatus. The presenting screen Q may indicate a candidate of the printer driver to be installed. Note that components substantially the same as those of the information processing system 1 according to the first example embodiment described above are denoted by the same reference numerals, and descriptions thereof are omitted where appropriate.

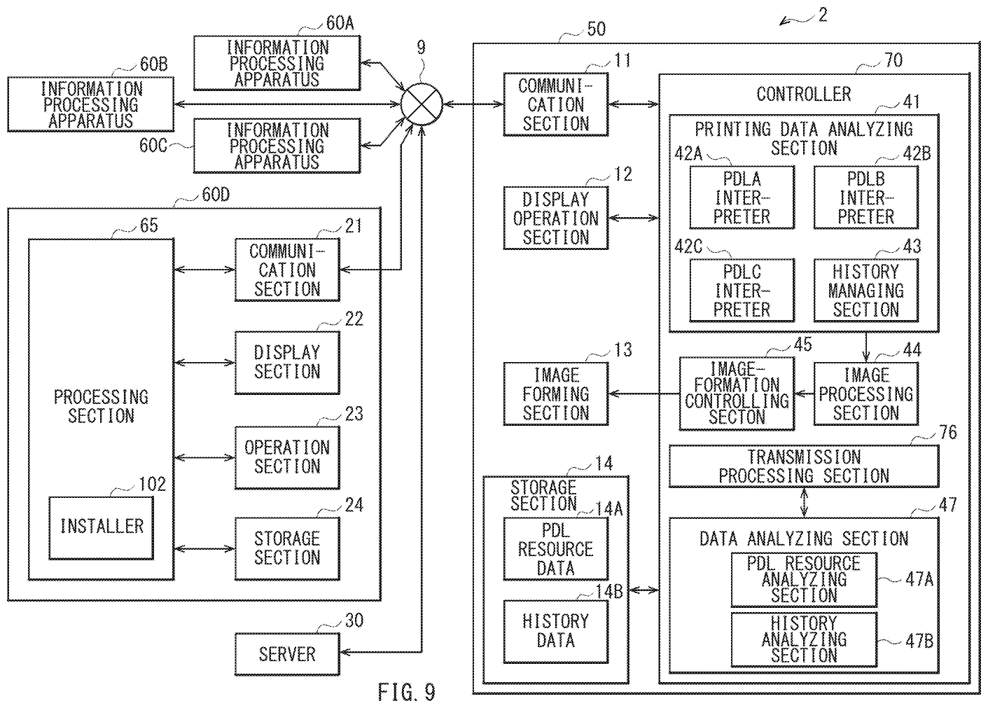

FIG. 9 illustrates an example of a configuration of the information processing system 2 according to the second example embodiment. The information processing system 2 may include an image forming apparatus 50 and two or more information processing apparatuses 60. In this non-limiting example, the information processing system 2 may include four information processing apparatuses 60A to 60D as the information processing apparatuses 60.

In the information processing system 2, when the user installs a printer driver on the information processing apparatus 60D, the image forming apparatus 50 may analyze the setting information (i.e., the PDL resource data 14A) regarding the two or more interpreters and the process history information (i.e., the history data 14B) of the interpreters. Further, the image forming apparatus 50 may supply information (analysis result information INF) indicating a result of the analysis to the information processing apparatus 60D. The information processing apparatus 60D that is to execute the installer may display, on the basis of the analysis result information INF, the presenting screen Q indicating a candidate of the printer driver to be installed, thereby presenting, to the user, the printer driver to be installed.

The image forming apparatus 50 may include a controller 70. The controller 70 may include a transmission processing section 76. The transmission processing section 76 may so control the communication section 11 that the communication section 11 transmits, as the analysis result information INF, the analysis result of the data analyzing section 47 to the information processing apparatus 60D.

The information processing apparatus 60D may include a processing section 65. The information processing apparatus 60D may be allowed to execute the installer 102 for installing the printer driver for the image forming apparatus 50. The processing section 65 may execute the installer 102 on the basis of operation performed by the user. The processing section 65 may thereby so control, on the basis of the analysis result information INF transmitted from the image forming apparatus 50, the display section 22 and the operation section 23 that the display section 22 displays the presenting screen Q indicating the candidate of the printer driver to be installed and the operation section 23 receives the choosing operation of the printer driver performed by the user.

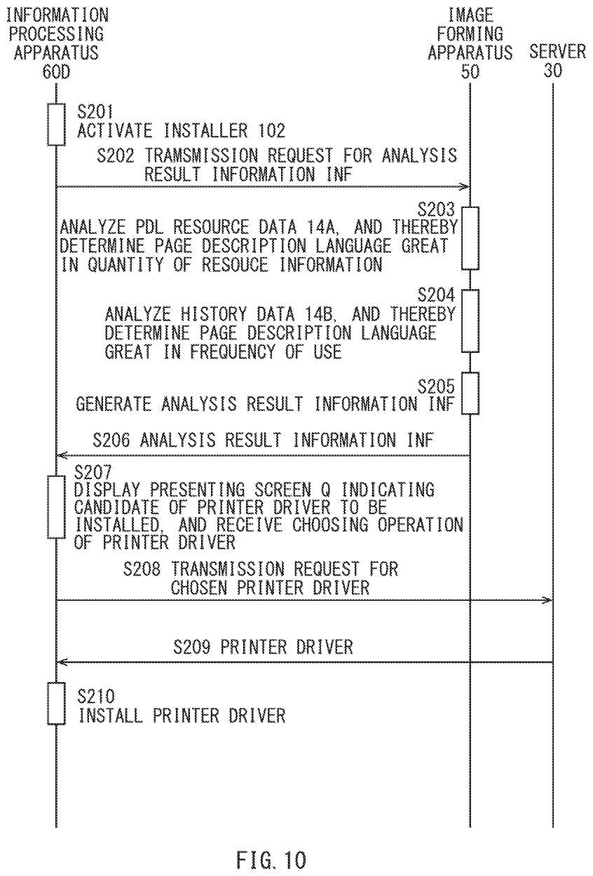

FIG. 10 illustrates an example of operation of the information processing system 2.

First, the processing section 65 of the information processing apparatus 60D may activate the installer 102 on the basis of operation performed by the user (step S201).

Thereafter, the information processing apparatus 60D may make, to the image forming apparatus 50, a transmission request for the analysis result information INF that is information regarding the analysis result on the PDL resource data 14A and the history data 14B (step S202). For example, the processing section 65 that is to execute the installer 102 may make a transmission request for the analysis result-information INF to the image forming apparatus 50. The communication section 21 of the information processing apparatus 60D may transmit the transmission request to the image forming apparatus 50. The communication section 11 of the image forming apparatus 50 may receive the transmission request.

Thereafter, the PDL resource analyzing section 47A of the image forming apparatus 50 may analyze the PDL resource data 14A, and may thereby determine the page description language that is great in quantity of the resource information among the page description languages PDLA, PDLB, and PDLC (step 203). Thereafter, the history analyzing section 47B of the image forming apparatus 50 may analyze the history data 14B, and may thereby determine the page description language that is great in frequency of use among the page description languages PDLA, PDLB, and PDLC (step S204). The steps S203 and S204 may be similar to the steps S102 and S103 according to the first example embodiment described above.

Thereafter, the transmission processing section 76 of the image forming apparatus 50 may generate the analysis result information INF on the basis of determination results obtained in steps S203 and S204 (step S205). In this example, as with the first example embodiment, the analysis result information INF may include: information indicating that the page description language PDLB is the page description language that is greatest in quantity of the resource information; information indicating that the page description language PDLA is the page description language that is greatest in frequency of use for all of the application; information indicating that the page description language PDLB is the page description language that is greatest in frequency of use for an application of printing the graphic-type to-be-printed data; and information indicating that the page description language PDLA is the page description language that is greatest in frequency of use for an application of printing the office-type to-be-printed data.

Thereafter, the communication section 11 of the image forming apparatus 50 may transmit the analysis result information INF described above to the information processing apparatus 60D (step S206). The communication section 21 of the information processing apparatus 60D may receive the transmitted analysis result information INF.

Thereafter, the display section 22 of the information processing apparatus 60D may display the presenting screen Q indicating the candidate of the printer driver to be installed, and the operation section 23 may receive choosing operation of the printer driver performed by the user (step S207). For example, the processing section 65 executing the installer 102 may generate, on the basis of the analysis result information INF received in step S206, the presenting screen Q indicating the candidate of the printer driver to be installed. Further, the processing section 65 may so control the display section 22 and the operation section 23 that the display section 22 displays the generated presenting screen Q and the operation section 23 receives the choosing operation performed by the user.

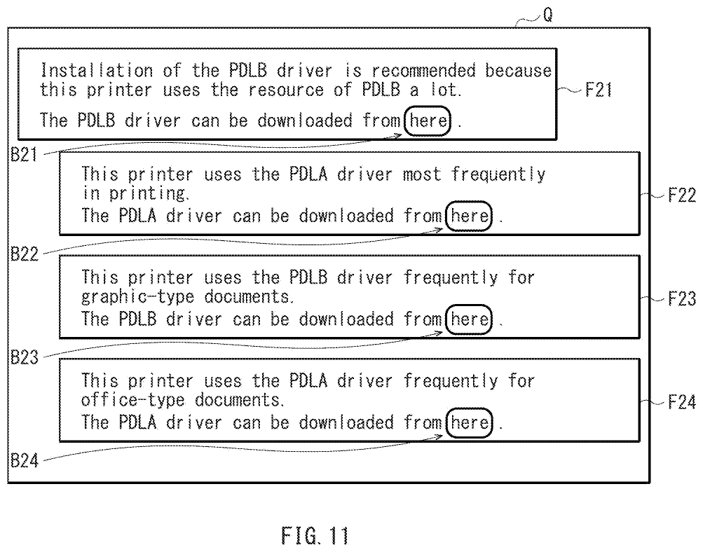

FIG. 11 illustrates an example of the presenting screen Q. The presenting screen Q may include four fields F21 to F24. The four fields F21 to F24 may correspond to the fields F1 to F4 illustrated in FIG. 7 in the first example embodiment, respectively. The four fields F21 to F24 may be provided with buttons B21 to B24, respectively. For example, when the user operates the button B21, the printer driver for the page description language PDLB may be downloaded from the server 30 in response the operation performed on the button B21 by the user. This may be similarly applicable to each of the buttons B22 to B24. The user may operate any of the buttons B21 to B24 to perform the choosing operation of the printer driver to be installed.

Thereafter, the processing section 65 of the information processing apparatus 60D may make, to the server 30, a transmission request for the chosen printer driver, in response to the choosing operation performed by the user, and the communication section 21 may transmit the transmission request to the server 30 (step 208). The server 30 may receive the transmitted transmission request. Thereafter, the server 30 may transmit, to the information processing apparatus 60D, the printer driver according to the transmission request from the information processing apparatus 60D, among the printer driver for the page description language PDLA, the printer driver for the page description language PDLB, and the printer driver for the page description language PDLC (step S209). The communication section 21 of the information processing apparatus 60D may receive the transmitted printer driver.

Thereafter, the processing section 65, of the information processing apparatus 60D, that is executing the installer 102 may install the printer driver received in step S209 on the information processing apparatus 60D (step S210).

This may bring the sequence to an end.

As described above, in the information processing system 2, the information processing apparatus 60D may execute the installer, thereby allowing for access to the image forming apparatus 50. This allows for easier access to the image forming apparatus 50. Accordingly, it is possible to improve user friendliness.

As described above, according to the second example embodiment, the information processing apparatus may execute the installer, thereby allowing for access to the image forming apparatus. Accordingly, it is possible to improve user friendliness. Other effects may be similar to those of the first example embodiment.

[Modification 2]

Any of the modifications of the first example embodiment described above may be applied to the information processing system 2 according to the second example embodiment.

### 3. Third Example Embodiment

Next, a description is given of an information processing system 3 according to a third example embodiment. The information processing system 3 may include an information processing apparatus that executes an installer for installing a printer driver. The information processing apparatus may analyze the PDL resource data 14A and the history data 14B. Note that components substantially the same as those of the information processing system 1 according to the first example embodiment described above are denoted by the same reference numerals, and descriptions thereof are omitted where appropriate.

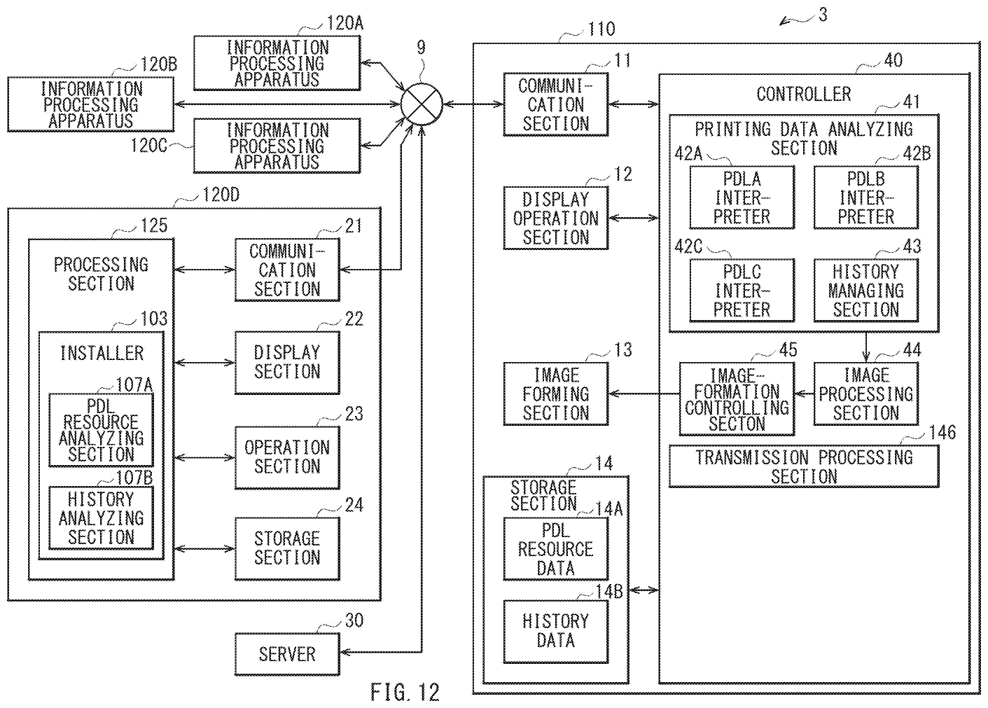

FIG. 12 illustrates an example of a configuration of the information processing system 3 according to the third example embodiment. The information processing system 3 may include, for example but not limited to, an image forming apparatus 110 and two or more information processing apparatuses 120. In this non-limiting example, the information processing system 3 may include four information processing apparatuses 120A to 120D as the information processing apparatuses 120.

In the information processing system 3, when the user installs a printer driver on the information processing apparatus 120D, the information processing apparatus 120D may acquire, from the image forming apparatus 110, the setting information (i.e., the PDL resource data 14A) regarding the two or more interpreters and the process history information (i.e., the history data 14B) of the interpreters. Further, the information processing apparatus 120D may analyze the acquired setting information (i.e., the PDL resource data 14A) and the acquired process history information (i.e., the history data 14B) of the interpreters. Further, the information processing apparatus 120D may display, on the basis of a result of the analysis, the presenting screen Q indicating a candidate of the printer driver to be installed, thereby presenting, to the user, the printer driver to be installed.

The image forming apparatus 110 may include a controller 140. The controller 140 may include a transmission processing section 146. The transmission processing section 146 may so control the communication section 11 that the communication section 11 transmits the PDL resource data 14A and the history data 14B to the information processing apparatus 120D.

The information processing apparatus 120D may include a processing section 125. The information processing apparatus 120D may be allowed to execute an installer 103 for installing the printer driver for the image forming apparatus 110. The installer 103 may include a PDL resource analyzing section 107A and a history analyzing section 107B. The PDL resource analyzing section 107A may analyze the PDL resource data 14A transmitted from the image forming apparatus 110, and may thereby determine the page description language that is great in quantity of the resource information, as with the PDL resource analyzing section 47A according to the first and the second example embodiments. The history analyzing section 107B may analyze the history data 14B transmitted from the image forming apparatus 110, and may thereby determine the page description language that is great in frequency of use, as with the history analyzing section 47B according to the first and the second example embodiments. Further, the processing section 125 may so control, on the basis of the results of the analyses performed by the PDL resource analyzing section 107A and the history analyzing section 107B, the display section 22 and the operation section 23 that the display section 22 displays the presenting screen Q indicating the candidate of the printer driver to be installed and that the operation section 23 receives the choosing operation of the printer driver performed by the user.

Here, the communication section 21 may correspond to a “communication section” of an “information processing apparatus” in one specific but non-limiting embodiment of the technology. The processing section 125 may correspond to a “processing section” and a “display controller” in one specific but non-limiting embodiment of the technology.

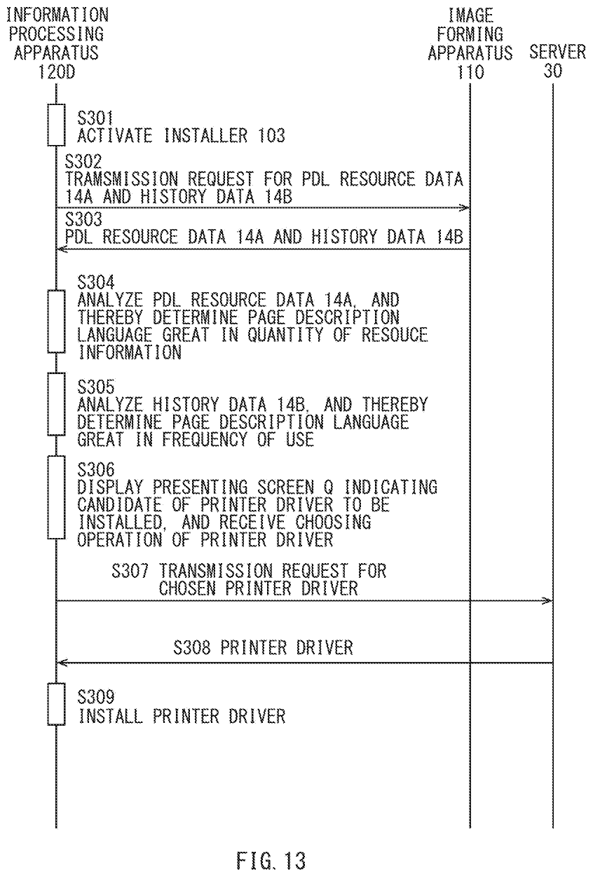

FIG. 13 illustrates an example of operation of the information processing system 3.

First, the processing section 125 of the information processing apparatus 120D may activate the installer 103 on the basis of operation performed by the user (step S301).

Thereafter, the information processing apparatus 120D may make, to the image forming apparatus 110, a transmission request for the PDL resource data 14A and the history data 14B (step S302). For example, the processing section 125 that is to execute the installer 103 may make, to the image forming apparatus 110, a transmission request for the PDL resource data 14A and the history data 14B. The communication section 21 of the information processing apparatus 120D may transmit the transmission request to the image forming apparatus 110. The communication section 11 of the image forming apparatus 110 may receive the transmission request.

Thereafter, the transmission processing section 146 of the image forming apparatus 110 may acquire the PDL resource data 14A and the history data 14B from the storage section 14, and the communication section 11 may transmit the acquired PDL resource data 14A and the acquired history data 14B to the information processing apparatus 120D (step S303). The communication section 21 of the information processing apparatus 120D may receive the transmitted PDL resource data 14A and the transmitted history data 14B.

Thereafter, the PDL resource analyzing section 107A of the information processing apparatus 120D may analyze the PDL resource data 14A, and may thereby determine the page description language that is great in quantity of the resource information among the page description languages PDLA, PDLB, and PDLC (step 304). Thereafter, the history analyzing section 107B of the information processing apparatus 120D may analyze the history data 14B, and may thereby determine the page description language that is great in frequency of use among the page description languages PDLA, PDLB, and PDLC (step S305). The steps S304 and S305 may be similar to the steps S102 and S103 according to the first example embodiment described above.

Thereafter, the display section 22 of the information processing apparatus 120D may display the presenting screen Q indicating the candidate of the printer driver to be installed, and the operation section 23 may receive choosing operation of the printer driver performed by the user (step S306). For example, the processing section 65 may generate, on the basis of results of the determination made in steps S304 and S305, the presenting screen Q indicating the candidate of the printer driver to be installed. Further, the processing section 125 may so control the display section 22 and the operation section 23 that the display section 22 displays the generated presenting screen Q and the operation section 23 receives the choosing operation performed by the user.

Thereafter, the processing section 125 of the information processing apparatus 120D may make, to the server 30, a transmission request for the chosen printer driver, in response to the choosing operation performed by the user, and the communication section 21 may transmit the transmission request to the server 30 (step 307). The server 30 may receive the transmitted transmission request.

Thereafter, the server 30 may transmit, to the information processing apparatus 120D, the printer driver according to the transmission request from the information processing apparatus 120D, among the printer driver for the page description language PDLA, the printer driver for the page description language PDLB, and the printer driver for the page description language PDLC (step S308). The communication section 21 of the information processing apparatus 120D may receive the transmitted printer driver.

Thereafter, the processing section 125 of the information processing apparatus 120D may install the printer driver received in step S308 on the information processing apparatus 120D (step S309).

This may bring the sequence to an end.

As described above, in the information processing system 3, the information processing apparatus 120D may execute the installer, thereby allowing for access to the image forming apparatus 110. This allows for easier access to the image forming apparatus 110. Accordingly, it is possible to improve user friendliness.

Moreover, in the information processing system 3, the information processing apparatus 120D may analyze the PDL resource data 14A and the history data 14B. Accordingly, it is possible to reduce a load of the process performed by the image forming apparatus 110.

As described above, according to the third example embodiment, the information processing apparatus may execute the installer, thereby allowing for access to the image forming apparatus. Accordingly, it is possible to improve user friendliness.

According to the third example embodiment, the information processing apparatus may analyze the PDL resource data and the history data. Accordingly, it is possible to reduce a load of the process performed by the image forming apparatus 110.

Other effects may be similar to those of the first example embodiment.

[Modification 2]

Any of the modifications of the first example embodiment described above may be applied to the information processing system 3 according to the third example embodiment.

Although the technology has been described with reference to some example embodiments and modifications thereof, the technology is not limited thereto, and may be modified in a variety of ways.

For example, in the example embodiments and the modifications described above, the image forming apparatus may support three page description languages; however, this is non-limiting. In one example embodiment, the image forming apparatus may support two page description languages or may support four or more page description languages.

For example, the example embodiments and the modifications described above, an embodiment of the technology may be applied to a single-function printer; however, this is non-limiting. Alternatively, an embodiment of the technology may be applied to a so-called multifunctional peripheral device (MFP) having multiple functions including, without limitation, a copy function, a fax function, a scan function, and a print function.

Furthermore, the technology encompasses any possible combination of some or all of the various embodiments and the modifications described herein and incorporated herein. It is possible to achieve at least the following configurations from the above-described example embodiments of the technology.

(1)

An information presenting method including:

performing an acquisition process, the acquisition process being a process of acquiring apparatus information, the apparatus information being stored in an image forming apparatus and including setting information, process history information, or both regarding two or more printing data analysis processes, the image forming apparatus selectively executing one of the printing data analysis processes on the basis of printing data;

performing a selecting process, the selecting process being a process of selecting one or more printer drivers of two or more printer drivers on the basis of the apparatus information acquired through the acquisition process, the two or more printer drivers corresponding to the respective printing data analysis processes; and

performing a display process, the display process being a process of displaying, on a priority basis, information regarding the one or more printer drivers selected through the selecting process.

(2)

The information presenting method according to (1), in which

the apparatus information includes the setting information,

the setting information includes resource information regarding each of the printing data analysis processes, the resource information being stored in the image forming apparatus,

the selecting process includes selecting, on the basis of the setting information, a first printer driver corresponding to a first printing data analysis process, the first printing data analysis process being one, of the printing data analysis processes, that is greatest in quantity of the stored resource information, and

the display process includes displaying information regarding the first printer driver on a priority basis.

(3)

The information presenting method according to (2), in which the resource information includes one or more of information regarding a macro, information regarding a font, and information regarding a color profile.

(4)

The information presenting method according to any one of (1) to (3), in which

the apparatus information includes the process history information,

the process history information includes information regarding number of times of execution of each of the printing data analysis processes,

the selecting process includes selecting, on the basis of the process history information, a second printer driver corresponding to a second printing data analysis process, the second printing data analysis process being one, of the printing data analysis processes, that is greatest in the number of times of execution, and

the display process includes displaying information regarding the second printer driver on a priority basis.

(5)

The information presenting method according to any one of (1) to (4), in which

the apparatus information includes the process history information,

the printing data includes to-be-printed data,

the process history information includes information regarding number of times of execution of each of the printing data analysis processes for each of two or more types of the to-be-printed data,

the selecting process includes selecting, on the basis of the process history information, a third printer driver corresponding to a third printing data analysis process, the third printing data analysis process being one, of the printing data analysis processes, that is greatest in the number of times of execution for one of the types of the to-be-printed data, and

the display process includes displaying, on a priority basis, information regarding the third printer driver in a state of being associated with the one of the types of the to-be-printed data.

(6)

The information presenting method according to any one of (1) to (5), further including

performing a generation process, the generation process being a process of generating page data of a WEB page including the information regarding the one or more printer drivers selected through the selecting process, in which

the image forming apparatus performs the acquisition process, the selecting process, and the generation process,

an information processing apparatus performs the display process, the information processing apparatus performing communication with the image forming apparatus, and

the display process includes displaying, on the basis of the page data, the information regarding the one or more printer drivers on a priority basis.

(7)

The information presenting method according to any one of (1) to (5), in which an information processing apparatus performs the acquisition process, the selecting process, and the display process, the information processing apparatus performing communication with the image forming apparatus.

(8)

The information presenting method according to any one of (1) to (7), the information regarding the one or more printer drivers includes a message that recommends a user to install any of the one or more printer drivers.

(9)

An image forming apparatus including:

a printing data analyzing section that selectively executes one of two or more printing data analysis processes on the basis of printing data;

a storage section that holds apparatus information, the apparatus information including setting information, process history information, or both regarding the printing data analysis processes;

a controller that selects one or more printer drivers of two or more printer drivers on the basis of the apparatus information, the two or more printer drivers corresponding to the respective printing data analysis processes; and

a communication section that transmits, to an information processing apparatus, information regarding the one or more selected printer drivers.

(10)

An information processing apparatus including:

a communication section that performs communication with an image forming apparatus and thereby acquires apparatus information, the image forming apparatus selectively executing one of two or more printing data analysis processes on the basis of printing data, the apparatus information including setting information, process history information, or both regarding the printing data analysis processes;

a processing section that selects one or more printer drivers of two or more printer drivers on the basis of the acquired apparatus information, the two or more printer drivers corresponding to the respective printing data analysis processes; and

a display controller that performs a display control, the display control being a control of displaying information regarding the one or more selected printer drivers on a prior basis.

According to the information presenting method, the image forming apparatus, and the information processing apparatus, one or more printer drivers of two or more printer drivers are selected on the basis of the apparatus information. The two or more printer drivers correspond to respective two or more printing data analysis processes. The apparatus information includes setting information, process history information, or both of the two or more printing data analysis processes. Further, information regarding the one or more selected printer drivers is displayed on a priority basis. As a result, it is possible to improve user friendliness.

Although the technology has been described in terms of exemplary embodiments, it is not limited thereto. It should be appreciated that variations may be made in the described embodiments by persons skilled in the art without departing from the scope of the invention as defined by the following claims. The limitations in the claims are to be interpreted broadly based on the language employed in the claims and not limited to examples described in this specification or during the prosecution of the application, and the examples are to be construed as non-exclusive. For example, in this disclosure, the term “preferably”, “preferred” or the like is non-exclusive and means “preferably”, but not limited to. The use of the terms first, second, etc. do not denote any order or importance, but rather the terms first, second, etc. are used to distinguish one element from another. The term “substantially” and its variations are defined as being largely but not necessarily wholly what is specified as understood by one of ordinary skill in the art. The term “about” or “approximately” as used herein can allow for a degree of variability in a value or range. Moreover, no element or component in this disclosure is intended to be dedicated to the public regardless of whether the element or component is explicitly recited in the following claims.

What is claimed is:

1. An information presenting method comprising:
performing an acquisition process, the acquisition process being a process of acquiring apparatus information, the apparatus information being stored in an image forming apparatus and including setting information, process history information, or both regarding two or more printing data analysis processes, the image forming apparatus selectively executing one of the printing data analysis processes on a basis of printing data;
performing a selecting process, the selecting process being a process of selecting one or more printer drivers of two or more printer drivers on a basis of the apparatus information acquired through the acquisition process, the two or more printer drivers corresponding to the respective printing data analysis processes; and
performing a display process, the display process being a process of displaying, on a priority basis, information regarding the one or more printer drivers selected through the selecting process.

2. The information presenting method according to claim 1, wherein
the apparatus information includes the setting information,
the setting information includes resource information regarding each of the printing data analysis processes, the resource information being stored in the image forming apparatus,
the selecting process includes selecting, on a basis of the setting information, a first printer driver corresponding to a first printing data analysis process, the first printing data analysis process being one, of the printing data analysis processes, that is greatest in quantity of the stored resource information, and
the display process includes displaying information regarding the first printer driver on a priority basis.

3. The information presenting method according to claim 2, wherein the resource information includes one or more of information regarding a macro, information regarding a font, and information regarding a color profile.

4. The information presenting method according to claim 1, wherein
the apparatus information includes the process history information,
the process history information includes information regarding number of times of execution of each of the printing data analysis processes,
the selecting process includes selecting, on a basis of the process history information, a second printer driver corresponding to a second printing data analysis process, the second printing data analysis process being one, of the printing data analysis processes, that is greatest in the number of times of execution, and
the display process includes displaying information regarding the second printer driver on a priority basis.

5. The information presenting method according to claim 1, wherein
the apparatus information includes the process history information,
the printing data includes to-be-printed data,
the process history information includes information regarding number of times of execution of each of the printing data analysis processes for each of two or more types of the to-be-printed data,
the selecting process includes selecting, on a basis of the process history information, a third printer driver corresponding to a third printing data analysis process, the third printing data analysis process being one, of the printing data analysis processes, that is greatest in the number of times of execution for one of the types of the to-be-printed data, and
the display process includes displaying, on a priority basis, information regarding the third printer driver in a state of being associated with the one of the types of the to-be-printed data.

6. The information presenting method according to claim 1, further comprising
performing a generation process, the generation process being a process of generating page data of a WEB page including the information regarding the one or more printer drivers selected through the selecting process, wherein
the image forming apparatus performs the acquisition process, the selecting process, and the generation process,
an information processing apparatus performs the display process, the information processing apparatus performing communication with the image forming apparatus, and
the display process includes displaying, on a basis of the page data, the information regarding the one or more printer drivers on a priority basis.

7. The information presenting method according to claim 1, wherein an information processing apparatus performs the acquisition process, the selecting process, and the display process, the information processing apparatus performing communication with the image forming apparatus.

8. The information presenting method according to claim 1, the information regarding the one or more printer drivers includes a message that recommends a user to install any of the one or more printer drivers.

9. An image forming apparatus comprising:
a printing data analyzing section that selectively executes one of two or more printing data analysis processes on a basis of printing data;
a storage section that holds apparatus information, the apparatus information including setting information, process history information, or both regarding the printing data analysis processes;
a controller that selects one or more printer drivers of two or more printer drivers on a basis of the apparatus information, the two or more printer drivers corresponding to the respective printing data analysis processes; and
a communication section that transmits, to an information processing apparatus, information regarding the one or more selected printer drivers.

10. An information processing apparatus comprising:
a communication section that performs communication with an image forming apparatus and thereby acquires apparatus information, the image forming apparatus selectively executing one of two or more printing data analysis processes on a basis of printing data, the apparatus information including setting information, process history information, or both regarding the printing data analysis processes;
a processing section that selects one or more printer drivers of two or more printer drivers on a basis of the acquired apparatus information, the two or more printer drivers corresponding to the respective printing data analysis processes; and
a display controller that performs a display control, the display control being a control of displaying information regarding the one or more selected printer drivers on a prior basis.
